(19) United States
(12) Patent Application Publication
(10) Pub. No.: US 2024/0091852 A1
(43) Pub. Date: Mar. 21, 2024

(54) METHOD FOR PRODUCING THREE-DIMENSIONAL MOLDED OBJECT

(71) Applicant: Sodick Co., Ltd., Kanagawa (JP)

(72) Inventor: Itaru MATSUMOTO, Kanagawa (JP)

(73) Assignee: Sodick Co., Ltd., Kanagawa (JP)

(21) Appl. No.: 18/518,662

(22) Filed: Nov. 24, 2023

Related U.S. Application Data
(63) Continuation of application No. 16/431,969, filed on Jun. 5, 2019.

(30) Foreign Application Priority Data
Jun. 7, 2018 (JP) 2018-109852

(51) Int. Cl. B22F 3/10; B22F 10/28; B22F 12/20; B22F 12/70; B22F 12/90; B33Y 40/00; B33Y 50/02

(52) U.S. Cl. CPC B22F 3/1028; B22F 10/28; B22F 12/20; B22F 12/70; B22F 12/90; B33Y 40/00; B33Y 50/02; B22F 2998/10; B33Y 10/00

(57) ABSTRACT

A method for producing a three-dimensional molded object includes a solidified layer forming step, a cooling step, and a warpage measuring step. The solidified layer forming step is performing a recoating step and a solidifying step and maintaining a solidified layer at a molding temperature which is equal to or more than a martensitic transformation start temperature. The cooling step is cooling the solidified layer from the molding temperature to a cooling temperature which is less than the molding temperature and equal to or less than a martensitic transformation finish temperature. The warpage measuring step is measuring warpage of the solidified layer or warpage of a portion that deforms with a deformation of the solidified layer. The solidified layer forming step and the cooling step are repeated while a difference between the molding temperature and the cooling temperature is changed according to the magnitude of the warpage.

### CROSS-REFERENCE TO RELATED APPLICATION

This application is a Continuation of U.S. patent application Ser. No. 16/431,969, filed on Jun. 5, 2019, which claims priority to Japanese Patent Application. No. 2018-109852 filed on Jun. 7, 2018, the entire contents of which are incorporated by reference herein.

### FIELD

The present invention relates to a method for producing a three-dimensional molded object.

### BACKGROUND

There is a plurality of methods for metal lamination molding. For example, in powder bed fusion, a material layer made of metal is formed on a molding table capable of vertical movement. Then, a predetermined portion of the material layer is irradiated with a laser beam or an electron beam to sinter or melt the material layer at the irradiated position to form a solidified layer. In this way, the formation of the material layer and the solidified layer are repeated, and a plurality of solidified layers are laminated to produce a desired three-dimensional molded object. Here, the chamber covering the molded table is preferably filled with inert gas. The first material layer and the first solidified layer may be formed on a base plate placed on the molding table. Hereinafter, Solidification includes sintering and melting. Further, a solidified body means an object formed by laminating a plurality of solidified layers. Also, a beam includes a laser beam and an electron beam.

In such metal lamination molding, the solidified layer formed by the irradiation with the beam on the material layer has a very high temperature immediately after solidification, and the temperature drops rapidly due to the heat radiation into the solidified layer, the base plate or an inert gas atmosphere. At this time, the solidified layer made of metal contracts in volume because a coefficient of thermal expansion of the metal is positive. However, since the solidified layer contacts with the adjacent solidified layer or the base plate, the amount of contraction is limited and a tensile stress remains.

If the material is martensitic metal, the solidified layer immediately after formation contains many austenite phases. At least a portion of these austenite phases is transformed to the martensitic phases by cooling with predetermined temperature conditions. Since martensitic transformation brings volume expansion, compressive stress is generated.

In Japanese Patent No. 6295001, the present applicant has proposed a method of controlling a residual stress of a molded object by intentionally advancing the martensitic transformation each time one or more solidified layers are formed, so as to reduce the tensile stress due to the contraction of the solidified layer(s) by the compressive stress due to the martensitic transformation. Predetermined temperature control is performed on the solidified layer(s) each time one or more solidified layers are formed, to advance the martensitic transformation intentionally.

### SUMMARY OF INVENTION

However, performing such a lamination molding method, a temperature suitable for achieving the desired stress relaxation differs depending on a shape, a size, or a type of material of the base plate and the solidified layer. Moreover, since it is difficult to predict the suitable temperature in advance, it is also difficult for an operator to set the suitable temperature for controlling the residual stress of the molded object to suppress a deformation.

The present invention has been made in consideration of the afore-mentioned circumstances. An object of the present invention is to perform temperature control more easily and appropriately in a method of producing a three-dimensional molded object in which martensitic transformation of a solidified layer is controlled by the temperature control.

According to the present invention, provided is a method for producing a three-dimensional molded object, comprising: a solidified layer forming step, wherein: performing a recoating step of forming a material layer on a predetermined molding region and a solidifying step of irradiating the material layer with a laser beam or an electron beam to form a solidified layer one or more times; and maintaining the solidified layer at a predetermined molding temperature; a cooling step of cooling the solidified layer from the molding temperature to a predetermined cooling temperature; and a warpage measuring step of measuring warpage of the solidified layer or warpage of a portion that deforms with a deformation of the solidified layer, wherein, the molding temperature is equal to or more than a martensitic transformation start temperature of the solidified layer, the molding temperature is more than the cooling temperature, and the cooling temperature is equal to or less than a martensitic transformation finish temperature of the solidified layer, and the solidified layer forming step and the cooling step are repeated while a difference between the molding temperature and the cooling temperature is changed according to the magnitude of the warpage.

In the present invention, temperature adjustment is performed to set the temperature suitable for suppressing the warpage of a solidified body, based on the magnitude of the warpage of the solidified body or a portion joined and integrated with the solidified body that deforms as the solidified body deforms. As a result, it is possible to perform the appropriate temperature adjustment that can easily reduce the deformation of the three-dimensional molded object without burdening the operator to find and set the suitable temperature according to their knowledge and experience.

### BRIEF DESCRIPTION OF THE DRAWINGS

FIG. 1 is a schematic configuration view of a lamination molding apparatus according to an embodiment of the present invention.

FIG. 2 is a perspective view of a recoater head according to the embodiment of the present invention.

FIG. 3 is a perspective view of the recoater head according to the embodiment of the present invention from another angle.

FIG. 4 is a schematic configuration view of an irradiation device according to the embodiment of the present invention.

FIG. 5 is a schematic configuration view of an example of a molding table provided with a temperature adjusting device according to the embodiment of the present invention.

FIG. 6 is a perspective view showing a mounting plate and a base plate.

FIG. 7 is a plan view showing the mounting plate and the base plate.

FIG. 8 is a cross-sectional view taken along the line A-A in FIG. 7.

FIG. 9 is a view showing a positional relationship between the base plate and a fixing bolt.

FIG. 10 is an explanatory view of a lamination molding method using the lamination molding apparatus according to the embodiment of the present invention.

FIG. 11 is an explanatory view of a lamination molding method using the lamination molding apparatus according to the embodiment of the present invention.

FIG. 12 is an explanatory view of a lamination molding method using the lamination molding apparatus according to the embodiment of the present invention.

FIG. 13 is a view showing a state in which a solidified body is formed on the base plate.

FIG. 14 is a graph showing the temperature change of a portion of an upper surface layer of the solidified body in the embodiment of the present invention.

FIG. 15A is a view showing an example of the solidified body 81 on the base plate 33 after a cooling step is performed.

FIG. 15B is a view showing another example of the solidified body 81 on the base plate 33 after the cooling step is performed.

FIG. 16A is a graph showing an example of the temperature change of the portion of the upper surface layer after a warpage measuring step.

FIG. 16B is a graph showing another example of the portion of the temperature change of the upper surface layer after the warpage measuring step.

### DETAILED DESCRIPTION

Hereinafter, the embodiments of the present invention will be described with reference to the drawings. The characteristic matters shown in the embodiments described below can be combined with each other. Moreover, each characteristic matter independently constitutes an invention.

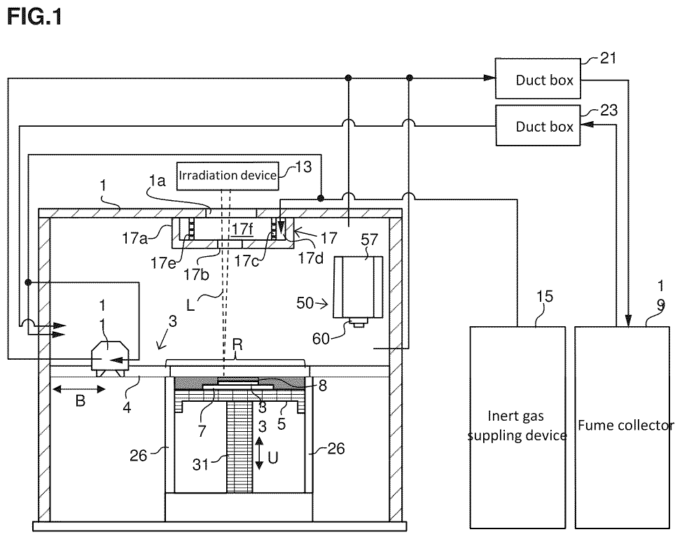

As shown in FIG. 1, a lamination molding apparatus according to the embodiment of the present invention repeats forming a material layer 8 made of martensitic metal and irradiating the material layer 8 with the beam L to solidify the material layer 8. The lamination molding apparatus laminates multiple solidified layers to produce a three-dimensional molded object having a desired shape. The martensitic metal of the material layer 8 is, for example, material powder of carbon steel or martensitic stainless steel.

The lamination molding apparatus of the present invention has a chamber 1 and an irradiation device 13. The chamber 1 covers a molding region R and is filled with inert gas having a predetermined concentration. A material layer forming device 3 is provided inside the chamber 1, and a protective window contamination preventing device 17 is provided on an upper surface of the chamber 1. The material layer forming device 3 has a base 4 and a recoater head 11.

The base 4 has the molding region R in which a solidified body 81 is formed. In the molding region R, a molding table 5 is provided. The molding table 5 can be moved in a vertical direction, which is showed as an arrow U in FIG. 1, by a molding table driving mechanism 31. When the lamination molding apparatus is used, a base plate 33 may be disposed on the molding table 5 and a first material layer 8 may be formed on the base plate 33. Preferably, a mounting plate 7 is arranged on the molding table 5 and the base plate 33 is fixed on the mounting plate 7. The molding region R is a region in which the desired solidified body 81 can be formed. An irradiation region is in the molding region R, and roughly matches an area defined by an outline shape of the desired solidified body 81.

Powder retaining walls 26 are provided around the molding table 5. Unsolidified material powder is retained in a powder retaining space surrounded by the powder retaining walls 26 and the molding table 5. Although not shown in FIG. 1, a powder discharging unit capable of discharging the material powder in the powder retaining space may be provided below the powder retaining walls 26. In such a case, the unsolidified material powder is discharged from the powder discharging unit by lowering the molding table 5 after the completion of the lamination molding. The discharged material powder is guided to a chute by a chute guide and is stored in a bucket through the chute.

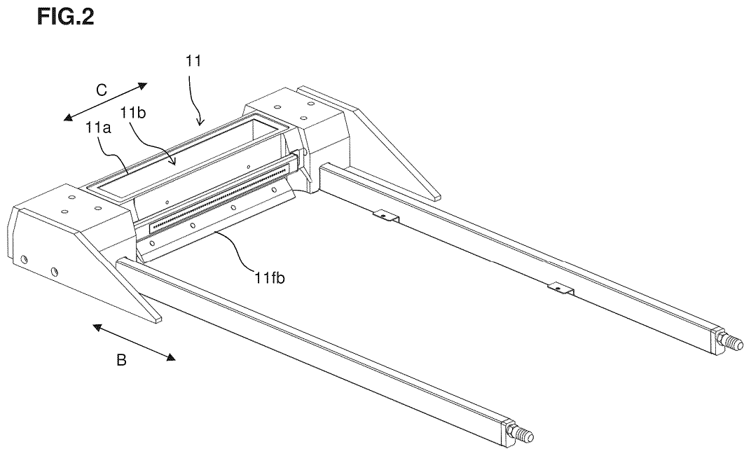

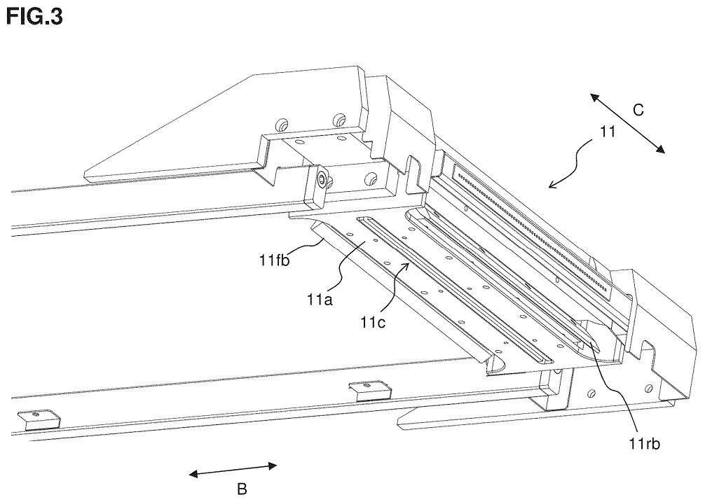

As shown in FIG. 2 and FIG. 3, the recoater head 11 has a material holding section 11a, a material supplying section 11b, and a material discharging section 11c. The material holding section 11a accommodates the material powder. The material supplying section 11b is provided on an upper surface of the material holding section 11a and serves as an opening receiving the material powder which is supplied from a material supplying device (not shown) to the material holding section 11a. The material discharging section 11c is provided on a bottom surface of the material holding section 11a and discharges the material powder accommodated in the material holding section 11a. The recoater head 11 moves along a horizontal direction showed as an arrow B. The material discharging section 11c has a slit shape extending in a horizontal direction showed as an arrow C, which is orthogonal to the arrow B.

A blade 11fb is provided on one side of the recoater head 11, while a blade 11rb is provided on the other side of the recoater head 11. The blades 11fb and 11rb spread the material powder. In other words, the blades 11fb and 11rb planarize the material powder discharged from the material discharging section 11c to form the material layer 8.

A cutting device 50 has a processing head 57 provided with a spindle 60. The processing head 57 moves the spindle 60 to a desired position by a processing head driving mechanism (not shown). The spindle 60 is configured so that a cutting tool, such as an end mill (not shown), can be attached on the spindle 60 and rotated. The spindle 60 can perform cutting of a surface or an unnecessary portion of the solidified layer. Preferably, plural types of cutting tools are used, and the cutting tools can be exchanged during molding by an automatic tool changer (not shown). The spindle 60 may hold a measuring element such as a touch sensor. At this time, it is preferable that the automatic tool changer be capable of exchanging the cutting tool and the measuring element during molding.

The protective window contamination preventing device 17 is provided on the upper surface of the chamber 1 so as to cover a protective window 1a. The protective window contamination preventing device 17 includes a cylindrical housing 17a and a cylindrical diffusion member 17c disposed in the housing 17a. An inert gas supplying space 17d is provided between the housing 17a and the diffusion member 17c. Further, an opening 17b is provided inside the diffusion member 17c on a bottom surface of the housing 17a. The diffusion member 17c is provided with a large number of pores 17e, and the clean inert gas supplied to the inert gas supplying space 17d is filled into a clean room 17f through the pores 17e. The clean inert gas filled in the clean room 17f is then ejected downward of the protective window contamination preventing device 17 through the opening 17b.

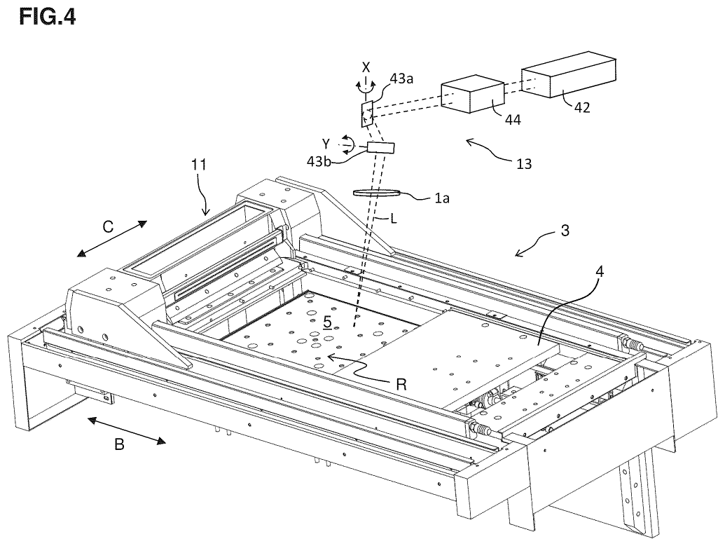

The irradiation device 13 is provided above the chamber 1. The irradiation device 13 irradiates a predetermined portion of the material layer 8 formed on the molding region R with the beam L to solidify the material layer 8 at an irradiated position. Specifically, as shown in FIG. 4, the irradiation device 13 has a light source 42, a focus control unit 44, and a two-axis galvanometer scanner. The galvanometer scanner has galvanometer mirrors 43a and 43b and actuators for rotating each of the galvanometer mirrors 43a and 43b.

The light source 42 emits a beam L. The beam L can solidify the material layer 8 and is, for example, a laser beam or an electron beam. As the laser beam, we may adopt a CO₂ laser, a fiber laser, or a YAG laser, for example.

The focus control unit 44 focuses the beam L output from the light source 42 to adjust it to a desired spot diameter.

The two-axis galvanometer scanner controls to scan two-dimensionally the beam L output from the light source 42. Rotational angles of the galvanometer mirrors 43a and 43b are controlled in accordance with magnitudes of rotational angle control signals input from a control device (not shown). With this feature, it is possible to irradiate a desired position with the beam L by changing the magnitude of the rotation angle control signal input to each actuator of the galvanometer scanner.

The beam L passed through the galvanometer mirrors 43a and 43b is transmitted through the protective window 1a provided in the chamber 1, and the material layer 8 formed in the molding region R is irradiated with the beam L. The protective window 1a is formed of material that can transmit the beam L. For example, if the beam L is a fiber laser or a YAG laser, the protective window 1a can be made of quartz glass.

The lamination molding apparatus according to the embodiment of the present invention includes a temperature adjusting device 90. The temperature adjusting device 90 adjusts a temperature of the newly formed solidified layer in the order of a molding temperature T1, a cooling temperature T2, and the molding temperature T1, every time one or more solidified layers are formed. Here, the molding temperature T1 and the cooling temperature T2 are included in a temperature range that can be adjusted by the temperature adjusting device 90. Here, following conditions (1), (2) and (3) are satisfied, that is;
(1) the molding temperature T1 is equal to or more than a martensitic transformation finish temperature Mf of the solidified layer;
(2) the molding temperature T1 is more than the cooling temperature T2; and
(3) the cooling temperature T2 is equal to or less than a martensitic transformation start temperature Ms of the solidified layer.

Here, as will be described later, in the present invention, warpage generated on the solidified body or on a portion integrated with the solidified body 81 which deforms with a deformation of the solidified body 81 is measured. At least one of the molding temperature T1 and the cooling temperature T2 may be changed according to a magnitude of the warpage. That is, a specific setting values of the molding temperature T1 or the cooling temperature T2 may be changed during molding as long as the above conditions (1) to (3) are satisfied.

In the following, the newly formed one or more solidified layers are also referred to as upper surface layers. In other words, the upper surface layers are solidified layers in which martensitic transformation is intentionally advanced by being cooled to the cooling temperature T2 after being maintained at the molding temperature T1 after molding. The upper surface layer is located on a top of the solidified body 81 constituted by the solidified layers. After solidification, the upper surface layer before being cooled contains austenite phases. The upper surface layer is cooled to the cooling temperature T2 to advance the martensitic transformation, and at least a part of the austenite phases in the upper surface layer becomes the martensitic phase.

The temperature adjusting device 90 is configured to adjust the temperature of the upper surface layer to the molding temperature T1 and the cooling temperature T2. Specifically, the temperature adjusting device 90 includes at least one of a heater 92 capable of heating the upper surface layer and a cooler 93 capable of cooling the upper surface layer, preferably includes both of the heater 92 and the cooler 93.

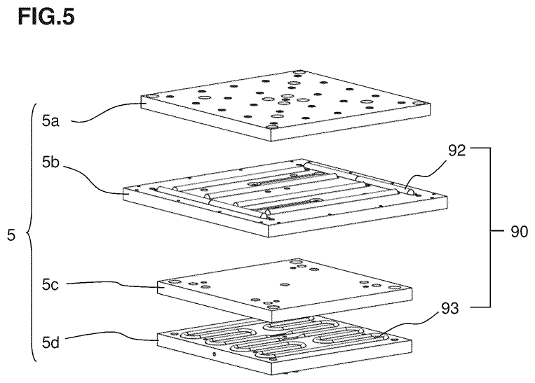

As an example, the temperature adjusting device 90 is provided at the molding table 5. As shown in FIG. 5, in the present embodiment, the molding table 5 having the temperature adjusting device 90 includes a top plate 5a and three support plates 5b, 5c, and 5d. The heater 92 capable of heating the top plate 5a is disposed between the top plate 5a and the support plate 5b adjacent to the top plate 5a. A cooler 93 capable of cooling the top plate 5a is disposed between the two support plates 5c and 5d below the support plate 5b. The molding table 5 is configured to be temperature adjustable by the heater 92 and the cooler 93. That is, the heater 92 and the cooler 93 constitute the temperature adjusting device 90.

In the embodiment shown in FIG. 5, the cooler 93 is configured such that pipes, through which a refrigerant flows, are sandwiched between the support plates 5c and 5d. Instead, for example, the cooler 93 may be configured to form cooling pipes directly on the support plates 5c and 5d by forming piping holes in one or both of the support plates 5c and 5d, and by combining the support plates 5c and 5d.

Moreover, in order to prevent thermal change of the molding table driving mechanism 31, a thermostatic unit maintained at a constant temperature may be provided between the temperature adjusting device 90 and the molding table driving mechanism 31.

By configuring the temperature adjusting device 90 as described above, it is possible to adjust the upper surface layer to the desired temperature via the mounting plate 7 in contact with the top plate 5a of the molding table 5 which is set to the desired temperature, the base plate 33, and lower solidified layers. Here, the material layer 8 is preferably preheated to a predetermined temperature for solidification, and the temperature adjusting device 90 also acts as a preheating device for the material layer 8. Specifically, at the time of forming the solidified layer, the material layer 8 is maintained at the molding temperature T1 by the temperature adjusting device 90.

The chamber 1 is supplied with the inert gas having the predetermined concentration and discharges the inert gas containing fume. The fume is generated when the material layer 8 is solidified. Specifically, a fume collector 19 is connected to the chamber 1 via an inert gas supplying device 15 and duct boxes 21 and 23.

The inert gas supplying device 15 has a function of supplying the inert gas, and is, for example, a device provided with a membrane type nitrogen separator that takes out nitrogen gas from ambient air. The inert gas supplying device 15 supplies the inert gas from a supply port provided in the chamber 1 and fills the chamber 1 with the inert gas having the predetermined concentration.

The inert gas containing a large amount of the fume exhausted from an exhaust port of the chamber 1 is sent to the fume collector 19. The fume is removed from the inert gas, and the inert gas is returned to the chamber 1. In the present invention, the inert gas does not substantially react with the material powder, and is appropriately selected from nitrogen gas, argon gas, helium gas, etc. according to a type of material.

### (Method for Producing Three-Dimensional Molded Object)

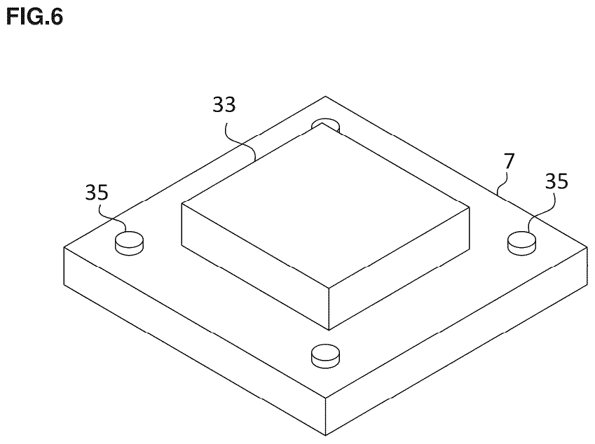

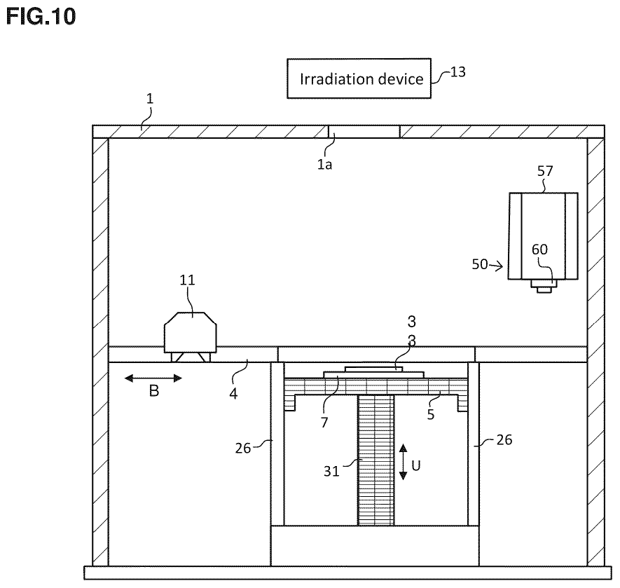

A method for producing the three-dimensional molded object using the afore-mentioned lamination molding apparatus will be described with reference to FIG. 6 to FIG. 16. It is noted that some of the components of the lamination molding apparatus shown in FIG. 1 are omitted in FIG. 10 to FIG. 12 in consideration of visibility. The method for producing three-dimensional molded object of the present embodiment includes a solidified layer forming step, a cooling step, and a warpage measuring step. In the solidified layer forming step, a recoating step of forming the material layer 8 on the molding region R and a solidifying step of irradiating the material layer 8 with the beam L to form the solidified layer are performed one or more times, and the solidified layer is maintained at the molding temperature T1. In the cooling step, the solidified layer is cooled from the molding temperature T1 to the cooling temperature T2. In the warpage measuring step, the warpage of the solidified layer or the portion that deforms with the deformation of the solidified layer is measured. Preferably, the method for producing three-dimensional molded object further includes a placing step and a cutting step. In the placing step, the base plate 33 on which the first material layer 8 and a first solidified layer 81 a are formed is placed in the molding region R so that the base plate 33 can be deformed with the deformation of the solidified layer. In the cutting process, an end face of the solidified layer is cut.

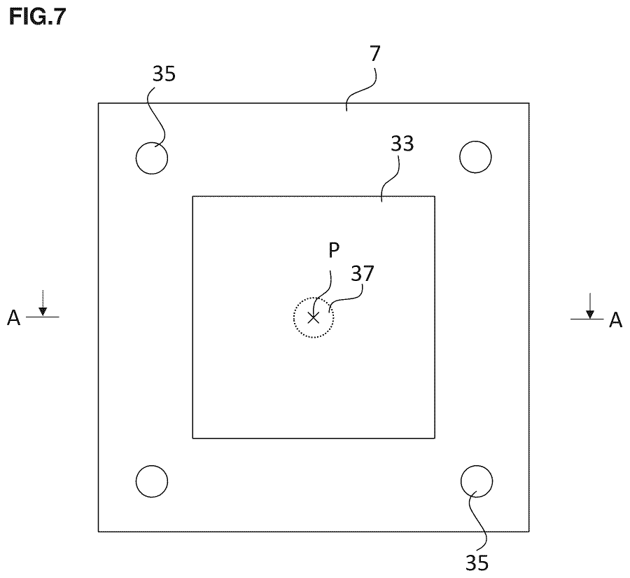

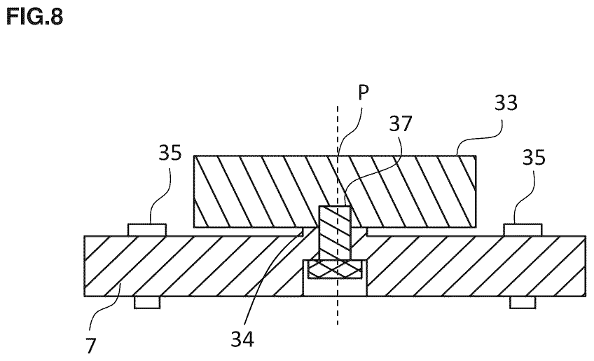

FIG. 6 is a perspective view showing the mounting plate 7 and the base plate 33 placed on the molding table 5. FIG. 7 is a plan view showing the mounting plate 7 and the base plate 33. FIG. 8 is a cross-sectional view taken along the line A-A in FIG. 7. In the method for producing the three-dimensional molded object according to the present invention, at first, the placing step of mounting the mounting plate 7 and the base plate 33 on the molding table 5 is performed.

First, the base plate 33 is fixed on the mounting plate 7. As shown in FIG. 7 and FIG. 8, the base plate 33 is fixed to the mounting plate 7 by a fixing bolt 37. A central portion of the base plate 33 is fixed to the mounting plate 7 so that the base plate 33 can be deformed with the deformation of the solidified layer formed on the base plate 33. The mounting plate 7 is provided in order to be able to fix and place the base plate 33 on the molding table 5 relatively easily in a deformable manner. In the present embodiment, as shown in FIG. 8, a convex portion 34 is formed on the central portion of the mounting plate 7 so as to allow a peripheral edge of the base plate 33 to be deformed upward or downward. The convex portion 34 and the base plate 33 are fixed by the fixing bolt 37.

Here, since there is a possibility that a position of the base plate 33 may be shifted due to a strong force generated with the deformation acting in a concentrated manner at a fixed point or due to receiving an external force, it is necessary to fix the base plate 33 so that displacement does not occur. The base plate 33 may be fixed to the mounting plate 7 at one or more as few positions as possible, at a position as close as possible to the center of the base plate 33, within a range where the positional displacement of the base plate 33 does not occur. In the present embodiment, the base plate 33 and the mounting plate 7 are fixed by one fixing bolt 37, however, two or more fixing points or other fixing means such as a clamp may be allowed.

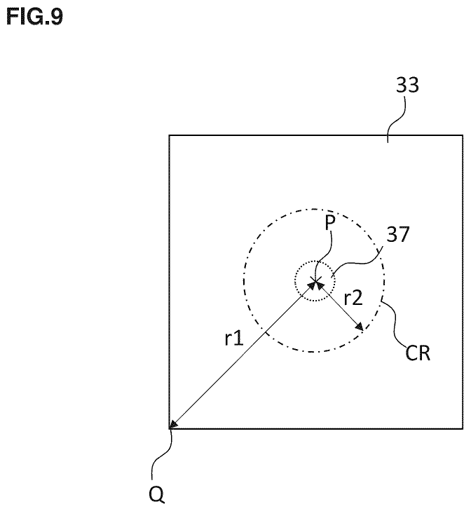

FIG. 9 shows a positional relationship between the base plate 33 and the fixing bolt 37. In the present embodiment, the material powder is made of martensitic stainless steel. The base plate 33 is made of carbon steel for machine structure (e.g., S50C specified by Japanese Industrial Standard), and a size is 150 mm×150 mm×20 mm Here, which position is fixed depends on the material, a shape, and the size of the base plate 33 and the material powder, so it is not limited to this example.

In FIG. 9, a length from a center of gravity P to an end portion Q in a plan view of the base plate 33 is shown as r1. Here, the end portion Q means a point of the base plate 33 which is most distant from the center of gravity P in the plan view. A circle centered on the center of gravity P of the base plate 33 is shown as CR, and a radius of the circle CR is shown as r2. Here, the position of the fixing bolt 37 is determined in which r2/r1 is equal to or less than 0.70. That is, the central portion of the base plate 33 may be a region defined by the circle CR in which r2/r1 is equal to or less than 0.70. Specifically, a value of r2/r1 may be, for example, 0.05, 0.10, 0.15, 0.20, 0.25, 0.30, 0.35, 0.40, 0.45, 0.50, 0.55, 0.60, 0.65, 0.70 and may be in a range between any two of the values shown hem. The number of fixing bolts 37 satisfying the above condition may be one or plural.

The mounting plate 7 to which the base plate 33 is attached is fixed to the molding table 5 by fixing bolts 35 at its four corners. In the present embodiment, the mounting plate 7 and the base plate 33 have a substantially square plane shape, but the present invention is not limited to this example. The mounting plate 7 and the base plate 33 are both made of metal such as iron or steel. The mounting plate 7 and the base plate 33 may be made of the same material, or different materials.

After the placing step, the solidified layer forming step is performed. In the solidified layer forming step, the recoating step and the solidifying step are performed once or more. The temperature of the solidified layer formed in the solidifying step is adjusted to the molding temperature T1. In the present embodiment, during the solidified layer forming step, the temperature of the molding table 5 is set to the molding temperature T1 by the temperature adjusting device 90, so the temperature of the material layer 8 and the temperature of the solidified layer are adjusted to the molding temperature T1.

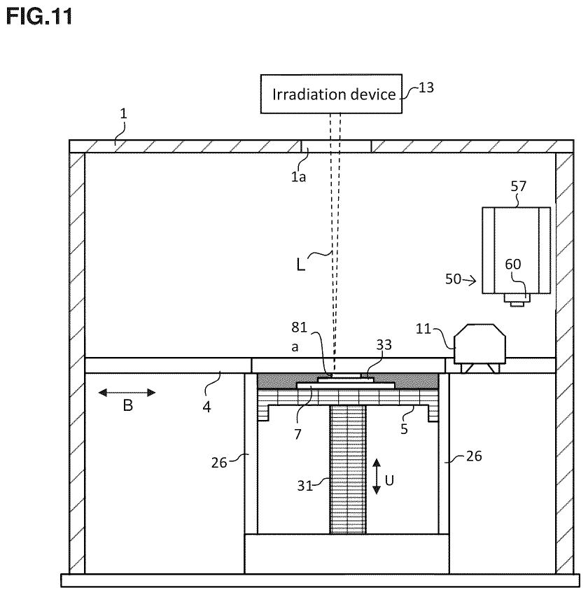

In the recoating step, first, as shown in FIG. 10, a height of the molding table 5 is adjusted to an appropriate position with the mounting plate 7 and the base plate 33 placed on the molding table 5. Next, as shown in FIG. 11, the recoater head 11 in which the material powder is filled in the material holding section 11a moves from a left side to a right side of the molding region R. As a result, the material powder is supplied onto the molding region R and flattened, and the material layer 8 is formed.

In the solidifying step, the irradiation region of the material layer 8 is irradiated with the beam L to be solidified, and the first solidified layer 81 a is formed on the base plate 33.

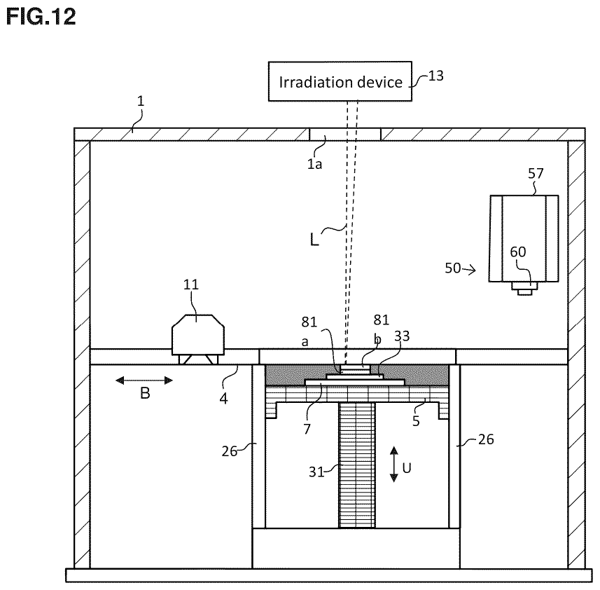

As shown in FIG. 12, in case that the cooling step is performed on a plurality of solidified layers, the recoating step and the solidifying step are subsequently performed again. First, the height of the molding table 5 is lowered by a thickness of the material layer 8. Next, the recoater head 11 moves from the right side to the left side of the molding region R to form the material layer 8 on the molding region R. Then, the irradiation region of the material layer 8 is irradiated with the beam L to be solidified, and a second solidified layer 81b is formed on the first solidified layer 81a.

As described above, in the solidified layer forming step, the solidified body 81 is formed by repeating the formation of the plurality of solidified layers. The solidified layers sequentially laminated are strongly fixed to each other. The recoating step and the solidification step are repeated until a predetermined number of solidified layers are formed.

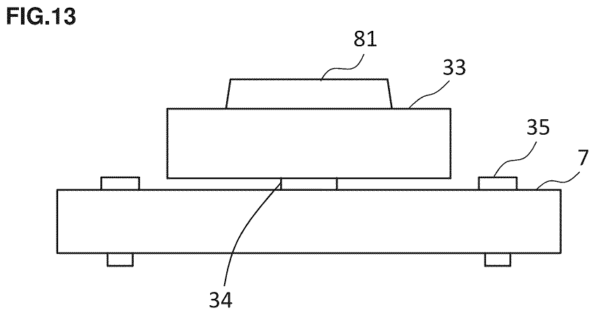

FIG. 13 shows a state in which the solidified body 81 is formed on the base plate 33 after the solidified layer forming step. Here, the temperature of the molding table 5 and the temperature of the solidified body 81 are adjusted to the molding temperature T1.

After the formation of one or more predetermined solidified layers, the cooling step is performed by the temperature adjusting device 90. In the cooling step, the temperature of the upper surface layer is lowered to the cooling temperature T2. In the present embodiment, the upper surface layer is cooled by changing the temperature of the molding table 5 from the molding temperature T1 to the cooling temperature T2. The temperature adjusting device 90 sets the temperature of the molding table 5 to the cooling temperature T2, and the temperature of the upper surface layer of the solidified body 81 decreases to the cooling temperature T2 via the mounting plate 7 and the base plate 33 placed on the molding table 5.

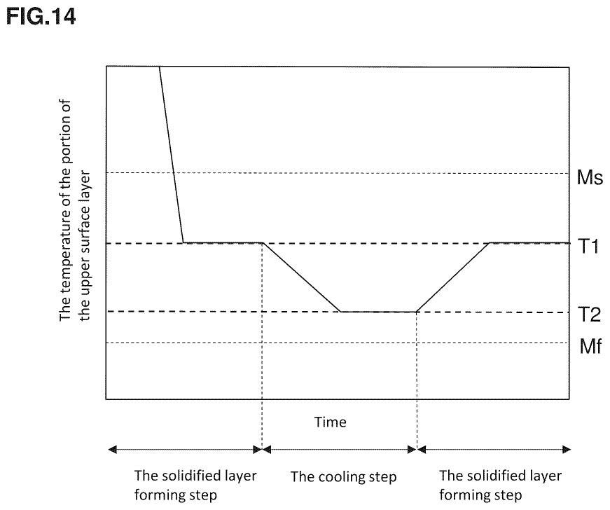

FIG. 14 is a graph showing an example of the temperature adjusting method of the upper surface layer in the solidified layer forming step and the cooling step. As shown in FIG. 14, in the solidifying step of the solidified layer forming step, a portion of the upper surface layer, namely the irradiated position, becomes very high temperature (for example, about 1500° C. to about 1600° C.) by the irradiation with the beam L. Thereafter, when the irradiation with the beam L is completed, the temperature of the portion of the upper surface layer decreases to be in thermal equilibrium with the temperature of the molding table 5 (that is, the molding temperature T1), and reaches the molding temperature T1 after predetermined time have passed. Then, in the cooling step, the temperature of the molding table 5 is changed from the molding temperature T1 to the cooling temperature T2, and the temperature of the upper surface layer is also lowered. When the temperature of the upper surface layer reaches the cooling temperature T2, the martensitic transformation proceeds. Compressive stress generated by expansion accompanying the martensitic transformation offsets tensile stress generated by contraction accompanying the cooling. After the cooling step, the temperature of the molding table 5 is set again to the molding temperature T1, and the solidified layer forming step is performed. Like this, the solidified layer forming step and the cooling step are repeated.

Here, as described above, the molding temperature T1 and the cooling temperature T2 are set to satisfy the following conditions (1), (2), and (3), that is:
(1) the molding temperature T1 is equal to or more than a martensitic transformation finish temperature Mf of the solidified layer;
(2) the molding temperature T1 is more than the cooling temperature T2; and
(3) the cooling temperature T2 is equal to or less than a martensitic transformation start temperature Ms of the solidified layer. The specific setting values of molding temperature T1 or the cooling temperature T2 may be changed as long as these conditions (1) to (3) are satisfied in each of the cooling steps. At this time, since the material is made of martensitic metal, the martensitic transformation occurs in the upper surface layer when the cooling is performed rapidly within a range between martensitic transformation start temperature Ms and martensitic transformation finish temperature Mf, and the volume expands with the martensitic transformation. Thereby, the tensile stress resulting from the contraction due to the cooling of the upper surface layer can be reduced. Here, an amount of the transformation, consequently an amount of the expansion, depends on a temperature difference between the molding temperature T1 and the cooling temperature T2. Theoretically, the amount of the expansion increases as the temperature difference between the molding temperature T1 and the cooling temperature T2 increases.

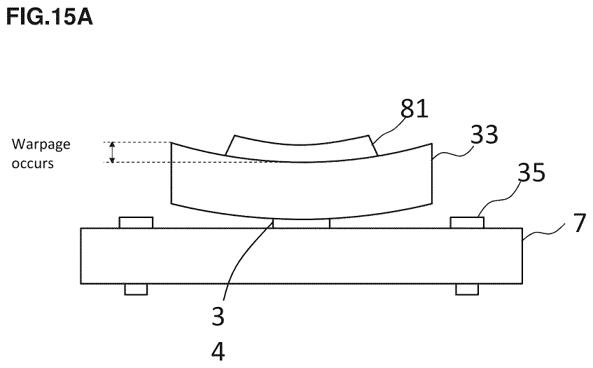

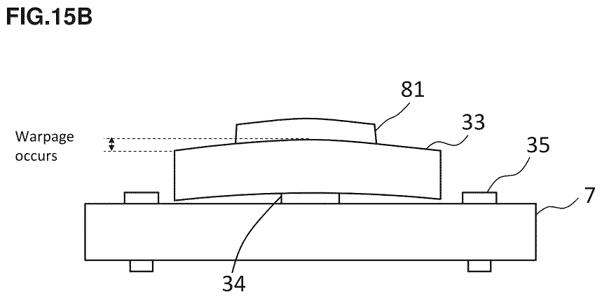

FIG. 15A and FIG. 15B show the solidified body 81 on the base plate 33 after the cooling step. In an example shown in FIG. 15A, the base plate 33 and the solidified body 81 are deformed so that their peripheral ends are warped upward. In the cooling step, the upper surface layer expands due to the martensitic transformation, and contracts due to the cooling. Then, if the amount of contraction due to the cooling exceeds the amount of expansion due to the martensitic transformation, the upper surface layer contracts as shown in FIG. 15A, and accordingly the base plate 33 is also deformed so that the peripheral edge is warped upward.

On the other hand, in an example shown in FIG. 15B, the base plate 33 and the solidified body 81 are deformed so that the peripheral end is warped downward. In the cooling step, if the amount of expansion due to the martensitic transformation exceeds the amount of contraction due to cooling, the upper surface layer expands as shown in FIG. 15B, and accordingly the base plate 33 also deforms so that the peripheral edge warps downward.

As described above, the volume expansion due to the martensitic transformation changes according to volume and shape of the solidified layer, the temperature difference in cooling, and the like. Thus, it is difficult to predict an optimum temperature setting for suppressing the contraction. As a result, if the molding temperature T1 and the cooling temperature T2 are set only before molding, such the warpage often occurs in the solidified body 81 and the base plate 33 after the cooling step. In the following description, as shown in FIG. 15A, the deformation such that the peripheral ends of the base plate 33 and the solidified body 81 are warped upward is referred to as “normal warpage direction deformation”, and as shown in FIG. 15B, the deformation such that the peripheral ends of the base plate 33 and the solidified body 81 are warped downward is referred to as “reverse warpage direction deformation”.

In the present embodiment, at least one warpage measuring step is performed while forming the desired three-dimensional molded object by repeating the solidified layer forming step and the cooling step. In the warpage measuring step, the warpage of the solidified layer or the warpage of the portion integrated with the solidified body 81 which is deformed with the deformation of the solidified layer is measured. In the present embodiment, the warpage of the portion integrated with the solidified body 81 which is deformed with the deformation of the solidified layer is measured. Specifically, the warpage of the base plate 33 is measured.

In the warpage measuring step in the present embodiment, the magnitude of the warpage of the base plate 33 is measured after the upper surface layer is cooled to the cooling temperature T2. Here, the magnitude of warpage is measured with the amount of deformation in the normal warpage direction as a positive value and the amount of deformation in the reverse warpage direction as a negative value. As a measuring method, first, a reference plane is set for the base plate 33 in advance. The reference plane is, for example, a bottom face of the base plate 33. Then, in the warpage measuring step, a displacement amount of an end portion of the bottom face of the base plate 33 from the reference plane or a change in curvature of the bottom face is measured. More specifically, for example, the measuring element such as the touch sensor may be attached to the processing head 57, and the measuring element is moved to a predetermined position to contact with an upper surface of the base plate 33. By acquiring measured data, the amount of warpage generated in the cooling step can be obtained and temperature adjustment can be performed automatically.

After the warpage measuring step, the difference between the molding temperature T1 and the cooling temperature T2 is changed according to the measured magnitude of warpage so that the warpage amount decreases, and the solidified layer forming step and the cooling step are repeated. In the present embodiment, the measured magnitude of warpage is compared with a predetermined threshold value. In the present embodiment, the value of the molding temperature T1 is changed according to the measured magnitude of warpage. If the magnitude of the measured warpage is larger than the threshold value, the molding temperature T1 is raised and a subsequent solidified layer forming step is performed. On the other side, if the magnitude of the measured warpage is smaller than the threshold value, the molding temperature T1 is lowered and the subsequent solidified layer forming step is performed. Here, it is preferable to raise the molding temperature T1 more as the size of the measured warpage is larger, and to lower the molding temperature T1 more as the size of the measured warpage is smaller.

Here, the threshold may be zero, or may be defined as a range from a specific negative value to a specific positive value which includes zero.

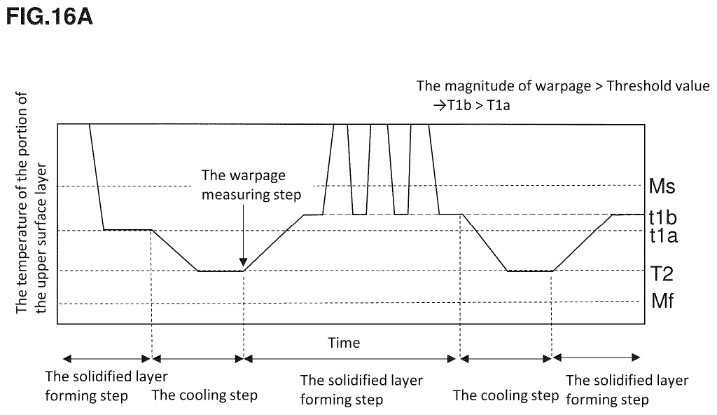

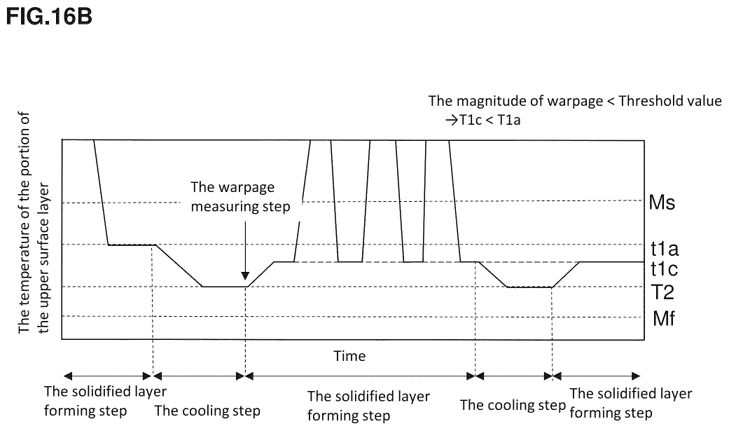

FIG. 16A shows the temperature change of the portion of the upper surface layer when the magnitude of the warpage is larger than the threshold value (that is, the temperature change of the normal warpage direction deformation). Like this, in the solidified layer forming step after the warpage measuring step, by setting the molding temperature T1 to t1b higher than t1a which is set before the warpage measuring step, the difference between the molding temperature T1 and the cooling temperature T2 in the cooling step following the warpage measuring step can be increased. In this way, it is possible to increase the amount of the martensitic transformation. As a result, the volume expansion amount of the upper surface layer is increased, and the normal warpage direction deformation can be suppressed.

FIG. 16B shows the temperature change of the portion of the upper surface layer when the magnitude of the warpage is smaller than the threshold value (that is, the temperature change of the reverse warpage direction deformation). Like this, in the solidified layer forming step after the warpage measuring step, by setting the molding temperature T1 to t1c lower than t1a which is set before the warpage measuring step, the difference between the molding temperature T1 and the cooling temperature T2 in the cooling step can be decreased. In this way, it is possible to decrease the amount of the martensitic transformation. As a result, the volume expansion amount of the upper surface layer is decreased, and the reverse warpage direction deformation can be suppressed.

When the magnitude of warpage matches the threshold value or within the threshold range having a predetermined range, the deformation due to volume expansion accompanying the martensitic transformation and the deformation due to contraction accompanying the cooling are seems to be in a desired balance. In this case, the solidified layer forming step and the cooling step are repeated without changing the molding temperature T1. According to the embodiment in which only the molding temperature T1 is changed, a time to lower the temperature to the cooling temperature T2 after the solidifying step can be relatively short. Moreover, the cooling temperature T2 is adjusted to constant which is the ambient temperature around the lamination molding apparatus, so it is effective in suppressing the subsequent deformation of the solidified body 81 and the displacement of the lamination molding apparatus.

As described above, in the present embodiment, the molding temperature T1 and the cooling temperature T2 are set based on the amount of warpage of the base plate 33 that deforms as the contracts or the expands due to the cooling of the solidified layer. As a result, it becomes possible to control the amount of expansion by the martensitic transformation more appropriately, and to form the three-dimensional molded object with warpage suppressed.

### Other Embodiments

The scope of application of the technical idea of the present disclosure is not limited to the above embodiment. For example, the fixing point of the base plate 33 is not limited to the central portion. Any method of fixing the base plate 33 may be used as long as the base plate 33 is deformed as the solidified body 81 is deformed. For example, the base plate 33 may be fixed along a center line of the base plate 33. As already mentioned, it is important that the base plate 33 is fixed not to move from the determined position, while the deformation is allowed so that the stress acting on the whole of the three-dimensional molded object including the base plate 33 and the solidified body 81 is released.

In the method for producing the three-dimensional molded object of the present invention, the material layer 8 may be formed directly on the molding table 5 without using the base plate 33 to form the solidified layer. Here, it is necessary to provide some means for supporting the solidified layer so as not to move and shift from the molding table 5. In this case, by measuring the magnitude of the warpage of the solidified body 81 instead of the base plate 33, the same effect of the above embodiment can be obtained. Alternatively, in the method of producing the three-dimensional molded object of the present invention, an object to be measured other than the base plate 33 and the solidified body 81 may be formed. The object to be measured may be a portion that is directly or indirectly coupled and integrated with the solidified body 81 and is deformed with the deformation of the solidified body 81. For example, the object to be measured is molded by laminating the solidified layer on the base plate 33. At this time, the magnitude of warpage of the object is measured.

Moreover, in the above embodiment, the molding temperature T1 is changed based on the magnitude of the warpage measured at the warpage measuring step, instead, the cooling temperature T2 may be changed. That is, when the magnitude of the warpage is larger than the threshold value, by setting the cooling temperature T2 to t2c lower than t2a which is set before the warpage measuring step, the difference between the molding temperature T1 and the cooling temperature T2 in the cooling step following the warpage measuring step can be increased. In this way, it is possible to increase the amount of the martensitic transformation. As a result, the volume expansion amount of the upper surface layer is increased, and the normal warpage direction deformation can be suppressed. When the magnitude of the warpage is smaller than the threshold value, by setting the cooling temperature T2 to t2b higher than t2a which is set before the warpage measuring step, the difference between the molding temperature T1 and the cooling temperature T2 in the cooling step following the warpage measuring step can be decreased. In this way, it is possible to decrease the amount of the martensitic transformation. As a result, the volume expansion amount of the upper surface layer is decreased, and the reverse warpage direction deformation can be suppressed. When the magnitude of warpage matches the threshold value or within the threshold value range having the predetermined range, the solidified layer forming step and the cooling step are repeated without changing the cooling temperature T2.

When the cooling temperature T2 is changed, it is effective in that the cooling temperature T2 can be set according to the change of the ambient temperature around the lamination molding apparatus. In addition, the cooling temperature T2 can be set to a temperature lower than the ambient temperature of a normal temperature of about 20° C. to 25° C. Thus, it is effective in that when the three-dimensional molded object is stored in an environment at a temperature lower than the normal temperature, continuous deformation of the molded object due to the martensitic transformation of the retained austenite phase can be suppressed to a smaller level.

Alternatively, the setting temperature of both the molding temperature T1 and the cooling temperature T2 may be changed. In the case where the molding temperature T1 and the cooling temperature T2 are simultaneously changed, it is possible to selectively obtain, within the required range, the advantage in the case where only one setting temperature of the molding temperature T1 or the cooling temperature T2 is changed.

Here, the martensitic transformation of the upper surface layer mainly proceeds between the martensitic transformation start temperature Ms and the martensitic transformation finish temperature Mf. That is, when changing the molding temperature T1 from t1a to t1b which is higher than t1a, it is desirable that t1a is lower than the martensitic transformation start temperature Ms. Also, when the molding temperature T1 is changed from t1a to t1c which is lower than t1a, it is desirable that t1c is lower than the martensitic transformation start temperature Ms. Also, when the cooling temperature T2 is changed from t2a to t2b which is higher than t2a, it is desirable that t2b is higher than the martensitic transformation finish temperature Mf. Also, when the cooling temperature T2 is changed from t2a to t2c which is lower than t2a, it is desirable that t2a is higher than the martensitic transformation finish temperature Mf.

It should be noted that the warpage measuring step may be performed once or more while repeating the solidified layer forming step and the cooling step. That is, the warpage measuring step may be performed after completion of the first cooling step or may be performed each time the cooling step is completed. In particular, in the case that the warpage amount is within a predetermined allowable range in the first warpage measuring step, and that the amount of warpage is known to change hardly after that in the lamination molding, there is no need to perform the warpage measuring step any more. Though, as the frequency of the warpage measuring step is increased, the expansion amount due to the martensitic transformation can be more accurately controlled.

Specifically, the molding temperature T1 or the cooling temperature T2 converges to an optimal temperature by repeating the warpage measuring step and repeating the increase or the decrease of the molding temperature T1 or the cooling temperature T2. Here, with regard to how the warpage measuring step is performed more specifically, for example, the warpage measuring step is programmed in advance in a molding program, and the warpage measuring step is performed at the automatically determined timing. As another embodiment, first, an allowable range of the warpage amount or a temperature change amount of the molding temperature T1 or the cooling temperature T2 is determined in advance. Then, the warpage measuring step is performed each time solidified layers having a predetermined number of layers are formed. In the case that the amount of warpage measured in the warpage measuring step becomes smaller than the predetermined allowable range, or that the temperature change amount of the molding temperature T1 or the cooling temperature T2 becomes smaller than a predetermined allowable range, a frequency of performing the subsequent warpage measuring step may be reduced, or the subsequent warpage measuring step may not be performed.

In the above embodiment, the warpage measuring step is performed after the temperature of the upper surface layer reaches the cooling temperature T2 and predetermined time has passed, but the present invention is not limited to this aspect. For example, the warpage measuring step may be performed immediately after the temperature of the upper surface layer reaches the cooling temperature T2 in the cooling step. Also, while the temperature of the upper surface layer is being cooled from the molding temperature T1 to the cooling temperature T2, the warpage is continuously measured, and when the warpage amount becomes zero, the cooling step may be interrupted at that timing. In this way, the cooling step can be ended at the time that the martensitic transformation proceeds until the tensile stress and the compressive stress are balanced, and the next solidified layer forming step can be performed.

Further, in the lamination molding apparatus including the cutting device 50 as in the present embodiment, the cutting step, for performing cutting process by the rotational cutting tool mounted on the spindle 60 to cut the end face of the solidified layer may be performed, every time a predetermined number of solidified layers are formed.

Further, the temperature adjusting device 9) may include at least one of a heater which heats the upper surface layer from an upper side of the upper surface layer and a cooler which cools the upper surface layer from the upper side of the upper surface layer. The heater is, for example, a halogen lamp. The cooler is, for example, a blower for blowing cooling gas of the same kind of the inert gas filled in the chamber 1 to the upper surface layer. Alternatively, the cooler is a cooling plate that is cooled by a Peltier element, a refrigerant, or the like. The cooling plate can be in contact with the upper surface layer. According to such a temperature adjusting device 90, the temperature of the upper surface layer can be directly adjusted to the molding temperature T1 and the cooling temperature T2, and the temperature of the upper surface layer can be adjusted rapidly even after forming the multiple solidified layers.

What is claimed is:

1. A method for producing a three-dimensional molded object, comprising:
(i) a placing step of placing a base plate on a molding table such that the base plate can be deformed with a deformation of solidified layers, wherein
the molding table is configured to adjust a temperature thereof according to a set value within an adjustable range including a molding temperature and a cooling temperature and be capable of moving in a vertical direction in a molding region,
the molding temperature is more than a martensitic transformation finish temperature of the solidified layers and the cooling temperature, and
the cooling temperature is less than a martensitic transformation start temperature of the solidified layers;
(ii) a first solidified layer forming step of forming the solidified layers on the base plate, comprising:
a first recoating step of forming a material layer in the molding region;
a first solidifying step of heating the material layer from the molding temperature to a sintering temperature or a melting temperature by irradiating the material layer with one of a laser beam and an electron beam;
repeating the first recoating step and the first solidifying step to form a predetermined number of the solidified layers; and
a first maintaining step of maintaining the solidified layers at the molding temperature, wherein
the molding table is kept at the molding temperature during the first recoating step, the first solidifying step and the first maintaining step;
(iii) a first cooling step of cooling the solidified layers from the molding temperature to the cooling temperature by the molding table is set at the cooling temperature and advancing martensitic transformation of the solidified layers so that tensile stress due to contraction of the solidified layers is reduced by compressive stress due to the martensitic transformation, after the first maintaining step;
(iv) an adjusting step performed after the first cooling step, comprising:
a warpage measuring step of measuring magnitude of warpage of the solidified layers or warpage of a portion that deforms with the deformation of the solidified layers; and
a temperature setting step of changing the set value of at least one of the molding temperature and the cooling temperature such that: a difference between the molding temperature and the cooling temperature becomes greater when the magnitude of warpage is more than threshold value; and the difference between the molding temperature and the cooling temperature becomes smaller when the magnitude of warpage is less than threshold value, wherein
the set value is changed within the adjustable range of the molding table in the temperature setting step as long as the following (a) to (d) are satisfied:
(a) the set value of the molding temperature before the temperature setting step is less than the martensitic transformation start temperature when the set value of the molding temperature is raised in the temperature setting step,
(b) the set value of the molding temperature after the temperature setting step is less than the martensitic transformation start temperature when the set value of the molding temperature is lowered in the temperature setting step,
(c) the set value of the cooling temperature after the temperature setting step is more than the martensitic transformation finish temperature when the set value of the cooling temperature is raised in the temperature setting step, and
(d) the set value of the cooling temperature before the temperature setting step is more than the martensitic transformation finish temperature when the set value of the cooling temperature is lowered in the temperature setting step,
(v) a second solidified layer forming step of forming the solidified layers on the solidified layers formed in the first solidified layer forming step, after the adjusting step, comprising:
a second recoating step of forming the material layer in the molding region;
second solidifying step of heating the material layer from the molding temperature to the sintering temperature or the melting temperature by irradiating the material layer with one of the laser beam and the electron beam;
repeating the second recoating step and the second solidifying step to form a predetermined number of the solidified layers; and
a second maintaining step of maintaining the solidified layers at the molding temperature, wherein
the molding table is kept at the molding temperature during the second recoating step, the second solidifying step and the second maintaining step; and
(vi) a second cooling step of cooling the solidified layers from the molding temperature to the cooling temperature by the molding table is set at the cooling temperature and advancing martensitic transformation of the solidified layers so that tensile stress due to contraction of the solidified layers is reduced by compressive stress due to the martensitic transformation, after the second maintaining step.

2. The method of claim 1, wherein in the warpage measuring step,
warpage of the base plate is measured.

3. The method of claim 1, wherein in the temperature setting step,
the set value of the molding temperature is changed higher when the magnitude of warpage is more than threshold value and
the set value of the molding temperature is changed lower when the magnitude of warpage is less than threshold value.

4. The method of claim 1, wherein in the temperature setting step,
the set value of the cooling temperature is changed lower when the magnitude of warpage is more than threshold value and
the set value of the cooling temperature is changed higher when the magnitude of warpage is less than threshold value.

5. The method of claim 1, wherein in the placing step,
a mounting plate having a convex portion on an upper surface is placed between the base plate and the molding table, and
a central portion of the base plate is fixed to the convex portion of the mounting plate.

6. The method of claim 5, wherein
the central portion is a region defined by a circle with a radius r2 centered on a center of gravity of the base plate in the plan view, and
when a length from the center of gravity to an end portion in the plan view of the base plate is r1, r2/r1 is equal to or less than 0.70.

7. The method of claim 1, wherein
the molding temperature is less than a martensitic transformation start temperature, and
the cooling temperature is equal to or more than a martensitic transformation finish temperature.

8. The method of claim 1, wherein the molding table comprises a heater and a cooler.
